(19) United States
(12) Patent Application Publication
(10) Pub. No.: US 2024/0377530 A1
(43) Pub. Date: Nov. 14, 2024

(54) METHOD FOR DETERMINING AT LEAST ONE ELEVATION VARIABLE OF AN OBJECT TARGET USING A MOTOR VEHICLE RADAR SYSTEM

(71) Applicant: VALEO SCHALTER UND SENSOREN GMBH, Bietigheim-Bissingen (DE)

(72) Inventors: Alexander Vanaev, Bietigheim-Bissingen (DE); Waqas Malik, Bietigheim-Bissingen (DE); Christian Sturm, Bietigheim-Bissingen (DE); Stefan Goerner, Bietigheim-Bissingen (DE)

(73) Assignee: VALEO SCHALTER UND SENSOREN GMBH, Bietigheim-Bissingen (DE)

(21) Appl. No.: 18/691,403

(22) PCT Filed: Sep. 13, 2022
(86) PCT No.: PCT/EP2022/075341

§ 371 Date: Mar. 12, 2024

(30) Foreign Application Priority Data
Sep. 16, 2021 (DE) 10 2021 123 942.7

(51) Int. Cl. G01S 13/931; G01S 13/46; G01S 13/58

(52) U.S. Cl. CPC G01S 13/931; G01S 13/46; G01S 13/589; G01S 2013/93271

(57) ABSTRACT

A method for determining at least one elevation variable of an object target of an object which is detected by a radar system of a vehicle, with respect to an elevation reference plane, is disclosed. The method includes emitting radar signals, receiving echo signals, determining a traveling velocity of the radar system, determining a radial velocity of an object target relative to the radar system, determining a direction variable which characterizes the direction of the object target relative to a first reference area, determining a second direction variable which characterizes the direction of the object target relative to a second reference area, and determining at least one elevation variable of the object target by means of at least one of the direction variables. Radar signals are emitted using at least one antenna of the radar system and echo signals are received using at least two antennas.

The invention relates to a method for determining at least one elevation variable of an object target of an object, which is detected by a radar system, in particular of a vehicle, with respect to an elevation reference plane, in which
radar signals are emitted and echo signals from radar signals reflected at the object target are received using the radar system,
a traveling velocity of the radar system is determined,
a radial velocity of the at least one object target relative to the radar system is determined using the radar system by means of the received echo signals,
a first direction variable, which characterizes the direction of the object target relative to a first reference area fixed in relation to the radar system, is determined using the radar system by means of the received echo signals,
a second direction variable, which characterizes the direction of the object target relative to a second reference area fixed in relation to the radar system, is determined by means of the first direction variable, the radial velocity, and the traveling velocity,
at least one elevation variable of the object target is determined by means of at least one of the direction variables.

Furthermore, the invention relates to a radar system, in particular of a vehicle, comprising
at least one antenna for emitting radar signals,
at least one antenna for receiving echo signals of radar signals reflected at object targets, and means for determining at least one elevation variable from object targets of objects detected using the radar system, with respect to an elevation reference plane, wherein the means have
means for determining radial velocities of detected object targets relative to the radar system by means of received echo signals,
means for determining first direction variables, which characterize directions of object targets relative to a first reference area fixed in relation to the radar system, by means of received echo signals,
means for determining second direction variables, which characterize directions of object targets relative to a second reference area fixed in relation to the radar system, by means of first direction variables, radial velocities, and a traveling velocity of the radar system, and means for determining at least one elevation variable of object targets by means of at least one of the direction variables.

Moreover, the invention relates to a vehicle having at least one radar system, wherein the
at least one radar system comprises
at least one antenna for emitting radar signals,
at least one antenna for receiving echo signals of radar signals reflected at object targets, and means for determining at least one elevation variable from object targets of objects detected using the radar system, with respect to an elevation reference plane, wherein the means have
means for determining radial velocities of detected object targets relative to the radar system by means of received echo signals,
means for determining first direction variables, which characterize directions of object targets relative to a first reference area fixed in relation to the radar system, by means of received echo signals,
means for determining second direction variables, which characterize directions of object targets relative to a second reference area fixed in relation to the radar system, by means of first direction variables, radial velocities, and a traveling velocity of the radar system, and means for determining at least one elevation variable of object targets by means of at least one of the direction variables.

### PRIOR ART

A method for radar-based measurement and/or classification of objects in a vehicle environment is known from DE 10 2018 000 517 A1, wherein the vehicle environment is detected by means of at least one radar sensor arranged on a vehicle and items of Doppler information are generated upon a determination and/or classification of a height of an object on the basis of an evaluation of a shift of a Doppler frequency between a radar signal emitted by the radar sensor and a radar signal reflected by the object. Under the presumption that items of accurate movement information of the vehicle are available, the height of the object can be determined in that the already determined information about the azimuth angle of the object is utilized together with the received Doppler information in order to accurately calculate the elevation angle. The azimuth angle of the object is determined by digital beam forming at multiple horizontal antennas of the radar sensor. If the elevation angle of the object has been calculated once, the height of the object can be determined from the elevation angle of the object and the radial distance from the radar sensor to the object, as specified in an equation.

The invention is based on the object of designing a method, a radar system, and a vehicle of the type mentioned at the outset in which the determination of at least one elevation variable of a detected object target with respect to an elevation reference plane can be implemented more efficiently. In particular, the at least one elevation variable is to be able to be determined more accurately and/or easily, in particular using simpler and/or space-saving means.

### DISCLOSURE OF THE INVENTION

The object is achieved according to the invention for the method in that radar signals are emitted using at least one antenna of the radar system and echo signals are received using at least two antennas of the radar system, wherein the respective phase centers of the antennas are arranged along an imaginary antenna axis which extends parallel to the elevation reference plane,
the first direction variable is determined relative to a first reference axis fixed in relation to the radar system as the reference area and the second direction variable is determined relative to a second reference axis fixed in relation to the radar system as the reference area.

According to the invention, the radar signals are emitted and received using antennas, the phase centers of which are arranged along an antenna axis. The antenna axis extends parallel to the elevation reference plane. In this way, the antenna arrangement of the radar system can be constructed linearly in a simple and space-saving manner. The arrangement of the antennas parallel to the elevation reference plane simplifies the assignment of the direction variables.

According to the invention, the first direction variable and the second direction variable are each determined in relation to an associated reference axis. The direction variables can thus be determined using a one-dimensional, linear antenna arrangement. A two-dimensional, planar antenna arrangement is not required for this purpose. In order to be able to determine at least one elevation variable directly in relation to the elevation reference plane, a two-dimensional, planar antenna arrangement is required. The invention enables at least one elevation variable to be determined with respect to the elevation reference plane of an object target using a space-saving and simply designed linear antenna arrangement.

The elevation reference plane extends horizontally with normal orientation of the radar system, in particular the vehicle. The azimuth is known to lie in a plane which extends parallel to the elevation reference plane or is the elevation reference plane. An azimuth reference plane, with respect to which the azimuth is defined, is perpendicular to the elevation reference plane.

The radial velocity of an object target is the relative velocity between the object target and the radar system in the direction of an imaginary connecting axis between the object target and a reference point of the radar system. The reference point of the radar system can advantageously be the intersection of the at least two reference axes.

The reference point, in particular the intersection of the at least two reference axes, or the projection of the reference point in the direction perpendicular to the elevation reference plane can advantageously lie between phase centers of the antennas, in particular on an imaginary antenna axis of the radar system.

The reference point, in particular the intersection of the at least two reference axes, can advantageously lie on a plane which is defined by the contact areas of the wheels of the vehicle on the ground. In this way, the reference system having the reference axes for the direction variables can be oriented to the roadway of the vehicle.

The traveling velocity of the radar system is the velocity at which the radar system moves in space. The traveling velocity of the radar system can advantageously be the traveling velocity of the vehicle. The traveling velocity can be specified as the velocity over ground or the like. The traveling velocity can advantageously be determined using a velocity measurement system, in particular of the vehicle.

The method is used to determine at least one elevation variable of an object target with respect to an elevation reference plane. An elevation variable can advantageously be an elevation height. Alternatively or additionally, an elevation variable can be an elevation angle. The elevation height is the distance between the object target and the elevation reference plane. The elevation angle is the angle between the imaginary connecting axis between the object target and the reference point of the radar system, on the one hand, and the elevation reference plane, on the other hand.

In addition, the azimuth of an object target can be determined using the method. In this way, both at least one elevation variable and the azimuth can be determined more accurately using the method.

Upon use in conjunction with a vehicle, the elevation height of an object target, which is in particular located in front of the vehicle in the direction of travel, can be determined using the invention. If the elevation height is known, it can be determined in particular using a driver assistance system of the vehicle whether the object target is arranged low enough that the vehicle can drive over it or the object target is arranged high enough that the vehicle can drive through below the object target.

Typically, only the azimuth of a detected object target can be determined using radar systems which only have a linear arrangement of multiple antennas, in particular emitting antennas and receiving antennas. The azimuth can be assumed here on the basis of a phase shift of echo signals. The echo signals are detected here using different receiving antennas. The azimuth can be determined accurately using such a radar system only in the case that the object target has the same elevation height as the phase centers of the antennas, in particular the receiving antennas. If the object target is located at a different elevation height than the antennas, the azimuth is determined inaccurately. To be able to determine both the azimuth and the elevation variable accurately, configurations of emitting antennas and receiving antennas arranged in a planar manner are typically used. In this case, additional emitting channels and receiving channels are necessary, using which exclusively the determination of the elevation variables is carried out. This increases the complexity and the cost expenditure for the radar systems used. This can be dispensed with in the invention.

Using the method according to the invention and the radar system according to the invention, distances and directions of object targets relative to the radar system, in particular relative to the vehicle, can be determined in a two-dimensional plane. The object target can be characterized in a three-dimensional space by an accurate determination of the at least one elevation variable. Overall, the invention enables a complete three-dimensional map of the environment of the radar system, in particular the vehicle, to be prepared. The invention enables both the determination of the azimuth and the determination of at least one elevation variable using a one-dimensional, linear antenna arrangement to be improved, without additional antennas, which are arranged in a planar manner in particular, in particular receiving antennas, being required for this purpose.

The radar system can advantageously be used in vehicles, in particular motor vehicles. The radar system can advantageously be used in land vehicles, in particular passenger vehicles, trucks, buses, motorcycles, or the like, aircraft, in particular drones, and/or wa-tercraft. The radar system can also be used in vehicles that can be operated autonomously or at least semiautonomously. However, the radar system is not restricted to vehicles. It can also be used in stationary operation, in robotics, and/or in machines, in particular construction or transport machinery, such as cranes, excavators, or the like.

The radar system can advantageously be connected to at least one electronic control device of a vehicle or machine, in particular a driver assistance system and/or a chassis control system and/or a driver information device and/or a parking assistance system and/or a gesture recognition system or the like, or can be part of such a device or system. In this way, at least some of the functions of the vehicle or of the machine can be per-formed autonomously or semiautonomously.

In an advantageous design of the method, the first direction variable can be determined from phase shifts between echo signals of the same radar signal received using various antennas. In this way, the first direction variable can be determined more accurately.

In one advantageous embodiment of the method, the second direction variable can be calculated from a mathematic, in particular trigonometric, relationship using the first direction variable, the radial velocity, and the traveling velocity, in particular a second direction variable in the form of a second direction angle as the arc sine of the quotient of the radial velocity and the product of the traveling velocity and the cosine of a first direction variable in the form of a first direction angle. In this way, the second direction variable can be calculated more accurately from already determined variables, in particular the first direction variable, the radial velocity, and the traveling velocity. The second direction variable can thus be individually determined more accurately. Corresponding conversion tables are not required for this purpose.

The second direction variable can advantageously be calculated in the form of a second direction angle as the arc sine of the quotient of the radial velocity and the product of the traveling velocity and the cosine of the first direction variable in the form of a first direction angle. In this way, direction variables can be calculated directly in the form of direction angles.

The second direction angle can advantageously be calculated according to the following formula:

$$β = {sin}^{- 1} ( \frac{{V}_{R}}{{V}_{H} cos α} )$$

In a further advantageous embodiment of the method, the second direction variable can be taken from a conversion table, which contains associations of first direction variables, second direction variables, radial velocities, and traveling velocities, in particular a second direction variable can be taken from a conversion table corresponding to the respective traveling velocity, which contains second direction variables as a function of first direction variables and radial velocities. In this way, the second direction variables can be determined quickly and without additional computing effort from already determined variables.

The at least one conversion table can be determined beforehand, in particular in the course of a calibration of the radar system, in particular at the end of the production line for the radar system or possibly the vehicle, and stored in a corresponding storage medium of the radar system, in particular a control and evaluation device.

A conversion table can advantageously be provided in each case for different traveling velocities, which contains the relationships between first direction variables, second direction variables, and radial velocities for the respective traveling velocity. In this way, the appropriate conversion table can be used depending on the respective traveling velocity.

The conversion table can advantageously have a plurality of triples each having a first direction variable, a radial velocity, and the corresponding second direction variable. Triples can be saved, in particular stored, easily, in particular in software.

In a further advantageous embodiment of the method, the first direction variable and the second direction variable can be implemented in the form of angles. In this way, the at least one elevation variable and/or azimuth of the detected object target can be determined more easily.

In a further advantageous embodiment of the method, the two reference axes can be specified so that they span a plane which extends parallel to the or in the elevation reference plane. In this way, the reference system for the direction variables and the reference system for the at least one elevation variable and the azimuth can have a common orientation. The at least one elevation variable and/or the azimuth can thus be determined more easily from the direction variables.

In a further advantageous embodiment, it can be checked before the determination of the second direction variable whether the detected object target is stationary, if the object target is not stationary, the method for determining at least one elevation variable for this object target can be ended, otherwise the method for determining at least one elevation variable can be continued. In this way, only stationary object targets are used to determine at least one elevation variable. The at least one elevation variable can be determined more accurately using stationary object targets.

After ending, the method for determining at least one elevation variable of an object target can advantageously be started again using another object target.

In a further advantageous embodiment of the method, to check whether the object target is stationary, a difference can be calculated between the radial velocity and the product of the traveling velocity with the cosine of the first direction variable,
the difference can be compared to at least one limiting value, and it can be assumed depending on the result of the comparison that the object target is stationary and the method for determining the at least one elevation variable can be continued, otherwise the method can be ended for this object target
and/or
the difference can be compared to two specified limiting values, and if the difference is between the two limiting values, it can be assumed that the object target is stationary and the method for determining the at least one elevation variable can be continued, otherwise the method can be ended for this object target. In this way, a velocity of an object target in space can be determined in consideration of the traveling velocity, the radial velocity, and the first direction variable in a mathematical manner, in particular by trigonometry.

The difference between the radial velocities and the product of the traveling velocity with the cosine of the first direction variable can advantageously be compared to at least one limiting value and it can be assumed depending on the result of the comparison that the object target is stationary. It can be assumed here that the object target is stationary if the difference is less than or less than/equal to the limiting value. Alternatively or additionally, it can be assumed that the object target is stationary if the difference is greater than or greater than/equal to the limiting value.

The two limiting values can advantageously have different signs. In this way, movements of the object target in the direction toward the radar system can be provided with a limiting value having a different sign than movements of the object target away from the radar system. The two limiting values can be specified so that possible movements of the detected object target can be determined within a tolerance, in particular a measuring tolerance of the radar system and/or for the traveling velocity.

In a further advantageous embodiment of the method, the at least one elevation variable and/or the azimuth of the object target can be calculated by means of the first direction variable and the second direction variable and/or taken from at least one conversion table.

In this way, the determined direction variables can be transformed with less effort into the at least one elevation variable and/or into the azimuth.

The at least one elevation variable and/or the azimuth of the object target can advantageously be calculated from the first direction variables and the second direction variable. A mathematic, in particular trigonometric, relationship can be used for this purpose.

The calculation of an elevation height as the elevation variable can be carried out according to the following formula:

h={square root over (R²(sin²(β)−cos²(α)))}

In this case, α is a first direction variable in the form of a direction angle, β is a second direction variable in the form of a direction angle, R is a distance of the object target from the radar system, and h is the elevation height.

A distance of the object target can advantageously be determined using the radar system. In this way, all variables which relate to the object target and are required to determine the at least one elevation variable can be determined using a single radar measurement.

Alternatively or additionally, the at least one elevation variable and/or the azimuth can be taken from at least one conversion table. In this way, the at least one elevation variable and/or the azimuth can be determined faster without additional computing effort.

Triples having possible elevation variables and respective first direction variables and second direction variables can advantageously be stored in the at least one conversion table. The at least one conversion table can be determined beforehand, in particular in the course of a calibration of the radar system, in particular at the end of the production line, and stored in a corresponding storage medium, in particular of the radar system.

Furthermore, the object is achieved according to the invention in the radar system in that the radar system has
at least one antenna, using which radar signals can be emitted, and at least two antennas, using which echo signals can be received from radar signals reflected at an object target, wherein the respective phase centers of the antennas are arranged along an imaginary antenna axis which extends parallel to the elevation reference plane,
a first reference axis fixed with respect to the radar system as the reference area for the first direction variable and a fixed second reference axis as the reference area for the second direction variable.

According to the invention, the antennas of the radar system are arranged linearly along the imaginary antenna axis. The antenna arrangement can be designed in a space-saving and simple manner in this way. Moreover, the antenna arrangement can be oriented in a defined manner with respect to the elevation reference plane. The at least one elevation variable can thus be determined more easily. The radar system has a fixed first reference axis and a fixed second reference axis, which are used as reference areas for the first direction variables and the second direction variable.

Moreover, the object is achieved according to the invention in the vehicle in that the at least one radar system has
at least one antenna, using which radar signals can be emitted, and at least two antennas, using which echo signals can be received from radar signals reflected at an object target, wherein the respective phase centers of the antennas are arranged along an imaginary antenna axis which extends parallel to the elevation reference plane,
a first reference axis fixed with respect to the at least one radar system as the reference area for the first direction variable and a fixed second reference axis as the reference area for the second direction variable.

Advantageously, at least one of the reference axes can be aligned on at least one defined imaginary axis of the vehicle, in particular a vehicle longitudinal axis, a vehicle transverse axis, and/or a vehicle vertical axis, and/or a direction of travel axis of the vehicle. In this way, the items of information obtained using the at least one radar system can be used more easily as items of environmental information for the vehicle.

The vehicle can advantageously have at least one driver assistance system. The vehicle can be operated autonomously or semiautonomously with the aid of a driver assistance system.

At least one radar system can advantageously be functionally connected to at least one driver assistance system. In this way, items of information about the environment of the vehicle which are obtained using the at least one radar system can be used by the at least one driver assistance system for autonomous or semiautonomous operation of the vehicle.

At least one radar system can advantageously be in particular an integral component of a driver assistance system and/or an automated driving system of the vehicle. Radar systems have the advantage that radial velocities of detected object targets can be determined directly using them.

Moreover, the features and advantages indicated in connection with the method according to the invention, the radar system according to the invention, and the vehicle according to the invention and the respective advantageous embodiments thereof apply here in a mutually corresponding manner and vice versa. The individual features and advantages can of course be combined with one another, wherein further advantageous effects that go beyond the sum of the individual effects may result.

### BRIEF DESCRIPTION OF THE DRAWINGS

Further advantages, features and details of the invention will become apparent from the following description, in which exemplary embodiments of the invention are explained in more detail with reference to the drawing. A person skilled in the art will expediently also consider individually the features that have been disclosed in combination in the drawing, the description and the claims and will combine them to form meaningful further combi-nations. In the schematic figures,

FIG. 1 shows a front view of a vehicle having a radar system for monitoring a monitoring area in front of the vehicle in the direction of travel, a driver assistance system, and a described measuring system;

FIG. 2 shows a three-dimensional representation of a driving situation of the vehicle from FIG. 1 having a Cartesian coordinate system fixed with respect to the radar system, having an object in front of the vehicle, wherein the vehicle is only indicated in a side view, not in perspective;

FIG. 3 shows a front view of an antenna arrangement of the radar system from FIG. 1 having a control and evaluation device, the driver assistance system, and the velocity measuring system;

FIG. 4 shows a three-dimensional representation of the Cartesian coordinate system from FIG. 2 from a different perspective with respect to a spherical representation;

FIG. 5 shows a conversion table for determining a second direction angle for an object target from a first direction angle and a radial velocity of the object target.

In the figures, identical elements are provided with identical reference signs.

### EMBODIMENT(S) OF THE INVENTION

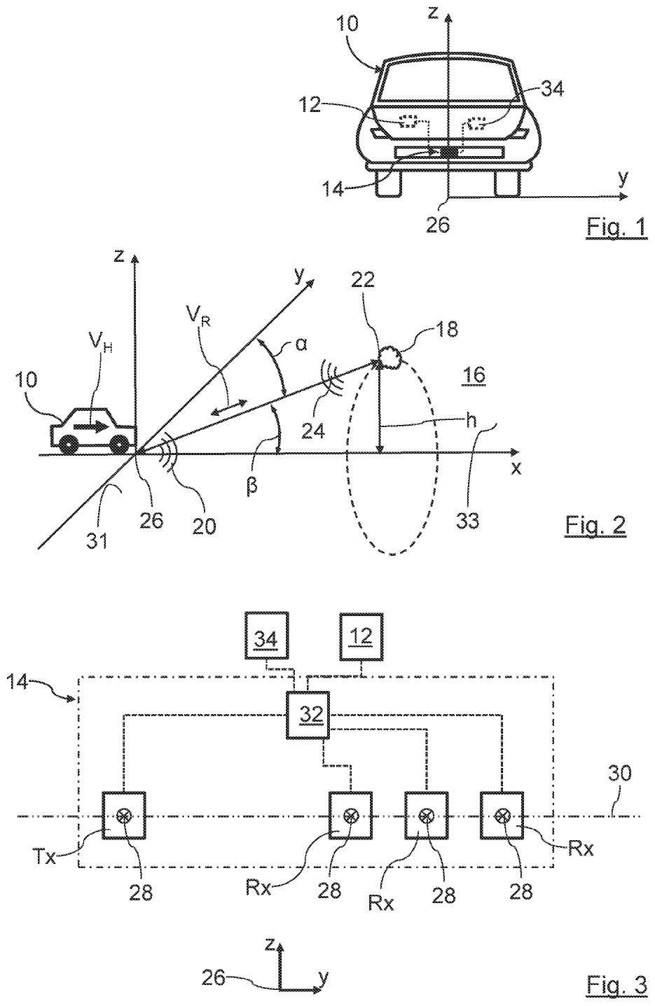

FIG. 1 shows the front view of a vehicle 10 in the form of a passenger vehicle. The vehicle 10 comprises a driver assistance system 12, a velocity measuring system 34, and a radar system 14. The radar system 14 is functionally connected to the driver assistance system 12, so that items of information which are obtained using the radar system 14 via a monitoring area 16 in front of the vehicle 10 in the direction of travel can be transmitted to the driver assistance system 12. Functions of the vehicle 10, for example driving functions, can be executed autonomously or semiautonomously using the driver assistance system 12.

The radar system 14 is arranged by way of example in the front fender of the vehicle 10 and is directed into the monitoring area 16. The radar system 14 can also be arranged at a different point of the vehicle 10 and can also be oriented differently.

Objects 18 in the monitoring area 16 can be detected using the radar system 14.

The objects 18 can be stationary or moving objects, for example vehicles, persons, ani-mals, plants, obstacles, roadway irregularities, for example potholes or rocks, roadway boundaries, traffic signs, open spaces, for example parking spaces, precipitation, or the like.

Radar signals 20 are emitted into the monitoring area 16 using the radar system 14 to detect objects 18. Radar signals 20 reflected at object targets 22 of objects 18 in the direction of the radar system 14 are received as echo signals 24 using the radar system 14. Items of object information, for example a distance R, a radial velocity V_{R}, elevation variables, for example an elevation angle Θ and an elevation height h, and an azimuth of the respective object target 22 relative to reference areas of the radar system 14 and thus relative to the vehicle 10 can be determined from the received echo signals 24.

An object target 22 is an area of an object 18 at which radar signals 20 can be reflected. An object 18 can have one or more such object targets 22. If the object 18 has multiple object targets 22, radar signals 20 can also be reflected differently thereon, for example in different directions.

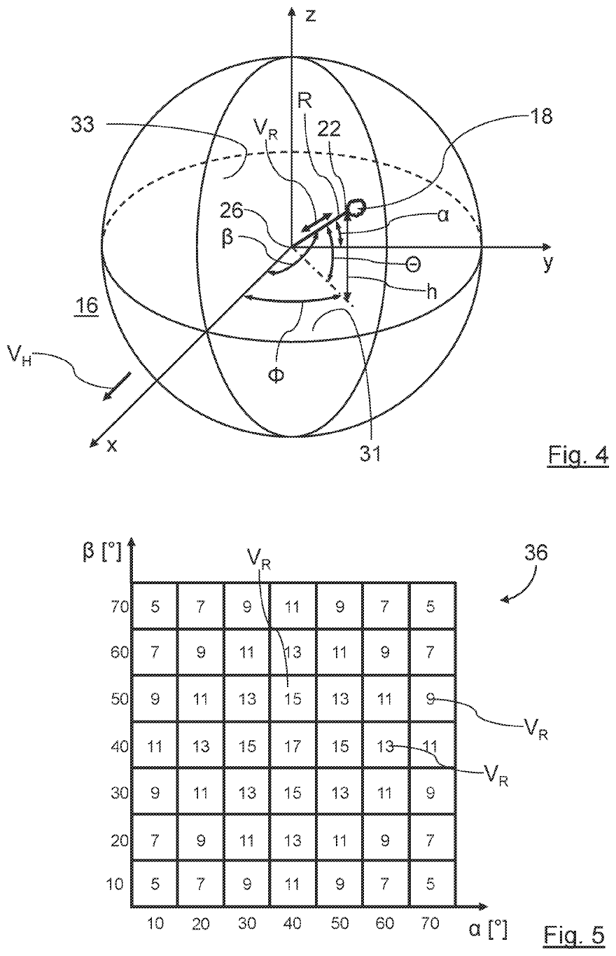

FIGS. 1 to 4 show the corresponding coordinate axes of an orthogonal x-y-z coordinate system. FIGS. 2 and 4 show the x-y-z coordinate system in a three-dimensional representation. The x axis of the x-y-z coordinate system extends, for example, parallel to a vehicle longitudinal axis of the vehicle 10 along the plane below the vehicle 10, which is spanned in the operating position of the vehicle 10 by the contact surfaces of the tires. The y axis extends parallel to a vehicle transverse axis of the vehicle 10 to the left viewed in the direction of travel. The z axis extends parallel to a vehicle vertical axis of the vehicle 10 spatially upward. A projection of a coordinate origin 26 of the x-y-z coordinate system in the direction of the z axis lies between an emitting antenna Tx and the receiving antennas Rx of the radar system 14. The coordinate origin 26 forms a fixed reference point of the radar system 14.

Respective phase centers 28 of the emitting antennas Tx and receiving antennas Rx are arranged on an imaginary antenna axis 30, as shown in FIG. 3. The antenna axis 30 extends parallel to the y axis and parallel to the x-y plane of the x-y-z coordinate system.

The x-y plane of the x-y-z coordinate system is the elevation reference plane 31 of the radar system 14. The x-z plane of the x-y-z coordinate system is the azimuth reference plane 33 of the radar system 14. The azimuth reference plane 33 is perpendicular to the elevation reference plane 31.

The radar system 14 has three receiving antennas Rx and one emitting antenna Tx as shown in FIG. 3. FIG. 3 shows the emitting antenna Tx and the receiving antennas Rx in the front view observed from the monitoring area 16 in the direction of the x axis. The receiving antennas Rx and the emitting antenna Tx are each functionally connected to a control and evaluation device 32 of the radar system 14. The control and evaluation device 32 is shown by way of example above the emitting antenna Tx and the receiving antennas Rx for better clarity. It can also be arranged at another point. Furthermore, the driver assistance system 12 and the velocity measuring system 34 are shown in FIG. 3.

The emitting antenna Tx can be activated to emit radar signals 20 using the control and evaluation device 32. Echo signals 24 can be received and converted into electrical signals using the receiving antennas Rx. The electrical signals can be transmitted to the control and evaluation device 32 and processed. For example, items of object information with respect to the detected objects 18 can be determined from the electrical signals.

The control and evaluation device 32 is connected to the driver assistance system 12. Items of information, for example the items of object information with respect to detected objects 18, determined using the control and evaluation device 32, can be transmitted to the driver assistance system 12 via the connection. The transmitted items of information can be used by the driver assistance system 12 for autonomous or semiautonomous operation of the vehicle 10.

A traveling velocity V_{H} of the vehicle 10 can be determined using the velocity measuring system 34. The velocity measuring system 34 is connected, for example, to the control and evaluation device 32. The determined traveling velocity V_{H} can thus be transmitted directly to the radar system 14. The velocity measuring system 34 can also be connected indirectly, for example via a control unit of the vehicle 10, to the radar system 14 and/or the driver assistance system 12.

The direction of a detected object target 22 relative to the radar system 14 is characterized by the azimuth ϕ and an elevation variable in the form of an elevation angle Θ. The azimuth ϕ and the elevation angle Θ of the object target 22 of the object 18 are shown in FIG. 4. FIG. 4 shows the coordinate system 26 in conjunction with a spherical representation for easier comprehensibility.

The azimuth ϕ is the angle between the azimuth reference plane 33 and the orthogonal projection of the connecting axis between the object target 22 and the coordinate origin 26 on the elevation reference plane 31. The elevation angle Θ is the angle between the elevation reference plane 31 and the connecting axis of the object target 22 with the coordinate origin 26. The azimuth ϕ and the elevation angle Θ characterize the direction of the object target 22 with respect to respective reference planes, namely the elevation reference plane 31 and the azimuth reference plane 33.

The direction of a detected object target 22 can be determined using the radar system 14 from the measurement of the phase differences of the received echo signals 24 between the three receiving antennas Rx. Due to the linear arrangement of the receiving antennas Rx, a first direction variable in the form of a first direction angle α can be determined from the phase differences.

The first direction angle α is the angle between the x axis and the connecting axis between the detected object target 22 and the coordinate origin 26. The x axis is a fixed first reference axis of the radar system 14 for the first direction angle α. The first direction angle α only corresponds to the azimuth ϕ if the detected object target 22 is in the elevation reference plane 31, i.e., at the same elevation height h as the radar system 14.

The elevation height h is the height above the elevation reference plane 31, thus the distance to the elevation reference plane 31. The elevation height h and the elevation angle Θ are each elevation variables which also characterize the position of the object target 12.

A second direction variable in the form of a second direction angle β can be determined from the first direction angle α, the radial velocity V_{R}, and the distance R of the detected object target 22.

The distance R is the distance of the detected object target 22 to the reference point of the radar system 14, namely the coordinate origin 26. The second direction angle β is the angle between the y axis and the connecting axis between the object target 22 and the coordinate origin 26. The y axis is a second fixed reference axis of the radar system for the second direction angle β.

Azimuth ϕ, elevation angle Θ, and elevation height h can be determined accurately for object targets 22 even when they are above or below the elevation reference plane 31 from the first direction angle α and the second direction angle β.

The method for determining the elevation variables, namely the elevation angle Θ and the elevation height h, and the azimuth for an object target 22 will be explained hereinaf-ter.

For this purpose, radar signals 20 are emitted using the emitting antenna Tx of the radar system 14. The echo signals 24, which are reflected at the object target 22, are received and converted into electrical signals using the receiving antennas Rx.

The first direction angle α is determined from the phase differences between the echo signals 24 received using the individual receiving antennas Rx. Furthermore, the radial velocity V_{R} and the distance R are determined from the echo signals 24. In addition, the traveling velocity V_{H} of the vehicle 10 is determined using the velocity measuring system 34.

It is then checked whether the detected object target 22 is stationary or moving. For this purpose, a check term in the form of a difference between the radial velocity V_{R} and the product of the traveling velocity V_{H} and the cosine of the first direction angle α is compared to a first limiting value TH1 and a second limiting value TH2 as follows:

$$TH 1 < {V}_{R} - {V}_{H} cos α < TH 2$$

The limiting values TH1 and TH2 are specified, for example, in consideration of the toler-ances in the determination of the distance R, the radial velocity V_{R}, and the traveling velocity V_{H}. For example, the lower limiting value TH1 can be a negative value. The upper limiting value TH2 can be a positive value. One of the limiting values TH can thus relate to radial velocities V_{R} of object targets 22 which move away from the radar system 14. The other limiting value TH can relate to radial velocities V_{R} of object targets 22 which move toward the radar system 14.

If the value of the check term is between the two limiting values TH1 and TH2, it is assumed that the object target 22 is stationary. For stationary object targets 22, the following determination of the azimuth ϕ and the elevation angle Θ can be carried out more accurately than is possible with moving object targets 22. To obtain a more accurate result, the method is therefore only continued using the object target 22 when it is stationary. If the check using the check term has the result that the object target 22 is not stationary, the method for determining the azimuth ϕ and the elevation variables, namely the elevation angle Θ and the elevation height h, is carried out again using another object target 22.

Under the presumption that the check has the result that the detected object target 22 is stationary, the second direction angle β is determined from the first direction angle α, the distance R, the radial velocity V_{R}, and the traveling velocity V_{H}. This can be carried out by means of calculation or by means of using a conversion table 36.

The calculation is carried out, for example, with the aid of the following trigonometric relationship:

$${V}_{R} = {V}_{H} sin βcosα$$

$$Accordingly$$

$$β = {sin}^{- 1} ( \frac{{V}_{R}}{{V}_{H} cos α} )$$

The calculation can be carried out by corresponding means on software and/or hardware. The means can be integrated in the control and evaluation device 32, for example.

Alternatively or additionally, the second direction angle β can be determined by means of conversion tables 36. For this purpose, for example, a group of conversion tables 36 is stored in the control and evaluation device. A visualization of one of these conversion tables 36 is shown by way of example in FIG. 5. The conversion tables 36 can be determined beforehand, for example in the course of a calibration of the radar system 14, for example at the end of the production line, and stored in corresponding storage media, for example, of the control and evaluation device 32.

Each conversion table 36 of the group corresponds to a specific traveling velocity V_{H} and contains the relationship between the first direction angle α, the second direction angle β, and the radial velocity V_{R} at this traveling velocity V_{H}. The conversion tables 36 can each have, for example, a plurality of triples, each having a first direction angle α, a radial velocity V_{R}, and the corresponding second direction angle β.

In the conversion table 36 shown in FIG. 5, the first direction angles α are shown in the horizontal direction and the second direction angles β are shown in the vertical direction. The different radial velocities V_{R} are indicated in the corresponding fields.

For better clarity, the values from 10° to 70° are shown in steps of 10 for the first direction angles α and the values from 10° to 70° are shown in steps of 10 for the second direction angles β solely by way of example. Radial velocities V_{R} are indicated with values of 5 m/s to 20 m/s by way of example. In practice, the conversion table 36 can contain significantly more values for the first direction angles α and the second direction angles β. Significantly more different negative and positive values can also be included for the radial velocities V_{R}.

The matching conversion table 36 for the traveling velocity V_{H} is used to determine the second direction angle β. If no matching conversion table 36 is present for the current traveling velocity V_{H}, the conversion table 36 for the traveling velocity closest to the current traveling velocity V_{H} can be used here. The corresponding second direction angle β is taken from the corresponding conversion table 36 for the already determined first direction angle α and the already determined radial velocity V_{R}.

If multiple second direction angles β are available for a first direction angle α and a radial velocity V_{R}, as is the case, for example, for the first direction angle α=50° in conjunction with the radial velocity V_{R}=13 m/s, for example, a plausibility check (of no further interest here) can be carried out to check which of the two offered second direction angles β is plausible.

The azimuth ϕ and the elevation angle Θ are then determined by trigonometry from the first direction angle α, the second direction angle β, and the distance R. Alternatively or additionally, the azimuth ϕ and the elevation angle Θ can be determined, for example, with the aid of one or more suitable conversion tables from the first direction angle α, the second direction angle β, and the distance R.

The elevation height h of the object target 22 is calculated from the following mathematical relationship:

h={square root over (R²(sin²(β)−cos²(α)))}

Therein, R is the distance, α is the first direction angle, and β is the second direction angle of the object target 12.

Alternatively or additionally, the elevation height h, instead of being determined from the first direction angle α, the second direction angle β, and the distance R, can also be determined from the elevation angle Θ and the distance R.

Using a following check, which can be carried out, for example, using means of the driver assistance system 12, it can be established with the aid of the elevation height h whether the object target 22 is located low enough or high enough that the vehicle 10 can drive through over it or under it free of collision.

1. A method for determining at least one elevation variable of an object target of an object, which is detected by a radar system of a vehicle, with respect to an elevation reference plane,
the method comprising:
emitting radar signals and receiving echo signals of radar signals reflected at the object target using the radar system,
determining a traveling velocity of the radar system,
determining a radial velocity of the at least one object target relative to the radar system using the radar system by means of the received echo signals,
determining a first direction variable, which characterizes the direction of the object target relative to a first reference area fixed in relation to the radar system, using the radar system by means of the received echo signals,
determining a second direction variable, which characterizes the direction of the object target relative to a second reference area fixed in relation to the radar system, by means of the first direction variable, the radial velocity, and the traveling velocity, and
determining at least one elevation variable of the object target by means of at least one of the direction variables,
wherein radar signals are emitted using at least one antenna of the radar system and echo signals are received using at least two antennas of the radar system,
wherein the respective phase centers of the antennas are arranged along an imaginary antenna axis, which extends parallel to the elevation reference plane,
wherein the first direction variable is determined relative to a first reference axis fixed in relation to the radar system as the reference area and the second direction variable is determined relative to a second reference axis fixed in relation to the radar system as the reference area.

2. The method as claimed in claim 1,
wherein the first direction variable is determined from phase shifts between echo signals of the same radar signal received using different antennas.

3. The method as claimed in claim 1,
wherein the second direction variable in the form of a second direction angle is calculated as the arc sine of the quotient of the radial velocity and the product of the traveling velocity and the cosine of a first direction variable in the form of a first direction angle.

4. The method as claimed in claim 1, wherein the second direction variable is taken from a conversion table corresponding to the respective traveling velocity, which contains second direction variables as a function of first direction variables and radial velocities.

5. The method as claimed in claim 1, wherein the first direction variable and the second direction variable are implemented in the form of angles.

6. The method as claimed in claim 1, wherein the two reference axes are specified so that they span a plane which extends parallel to or in the elevation reference plane.

7. The method as claimed in claim 1, further comprising, before the determination of the second direction variable, checking whether the detected object target is stationary, and if the object target is not stationary, the method for determining at least one elevation variable is ended for this object target.

8. The method as claimed in claim 7, further comprising:
to check whether the object target is stationary, calculating a difference between the radial velocity and the product of the traveling velocity with the cosine of the first direction variable,
comparing the difference to at least one limiting value,
wherein it is assumed depending on the result of the comparison that the object target is stationary and the method for determining the at least one elevation variable is continued, otherwise the method is ended for this object target, or,
comparing the difference to two specified limiting values and, if the difference is between the two limiting values, it is assumed that the object target is stationary and the method for determining the at least one elevation variable is continued, otherwise the method is ended for this object target.

9. The method as claimed in claim 1, wherein the at least one elevation variable and/or the azimuth of the object target is calculated by means of the first direction variable and the second direction variable and/or is taken from at least one conversion table.

10. A radar system of a vehicle, comprising:
at least one antenna for emitting radar signals,
at least two antennas for receiving echo signals from radar signals reflected at object targets, and
means for determining at least one elevation variable of object targets of objects detected using the radar system, with respect to an elevation reference plane,
wherein the means comprise:
means for determining radial velocities of detected object targets relative to the radar system by means of received echo signals,
means for determining first direction variables, which characterize directions of object targets relative to a first reference area fixed in relation to the radar system, by means of received echo signals,
means for determining second direction variables, which characterize directions of object targets relative to a second reference area fixed in relation to the radar system, by means of first direction variables, radial velocities and a traveling velocity of the radar system, and
means for determining at least one elevation variable of object targets by means of at least one of the direction variables,
wherein the respective phase centers of the antennas are arranged along an imaginary antenna axis, which extends parallel to the elevation reference plane, a first reference axis fixed in relation to the radar system as the reference area for the first direction variable, and a fixed second reference axis as the reference area for the second direction variable.

11. A vehicle comprising at least one radar system,
wherein the at least one radar system comprises:
at least one antenna for emitting radar signals,
at least two antennas for receiving echo signals from radar signals reflected at object targets, and
means for determining at least one elevation variable of object targets of objects detected using the radar system, with respect to an elevation reference plane,
wherein the means comprise:
means for determining radial velocities of detected object targets relative to the radar system by means of received echo signals,
means for determining first direction variables, which characterize directions of object targets relative to a first reference area fixed in relation to the radar system, by means of received echo signals,
means for determining second direction variables, which characterize directions of object targets relative to a second reference area fixed in relation to the radar system, by means of first direction variables, radial velocities and a traveling velocity of the radar system, and
means for determining at least one elevation variable of object targets by means of at least one of the direction variables,
wherein the respective phase centers of the antennas are arranged along an imaginary antenna axis, which extends parallel to the elevation reference plane, a first reference axis fixed in relation to the at least one radar system as the reference area for the first direction variable, and a fixed second reference axis as the reference area for the second direction variable.
